(19) United States
(12) Patent Application Publication
(10) Pub. No.: US 2025/0123455 A1
(43) Pub. Date: Apr. 17, 2025

(54) SUBSTRATE BASED TRAVELING WAVE OPTOELECTRONIC DEVICE

(71) Applicant: OpenLight Photonics, Inc., Goleta, CA (US)

(72) Inventor: John Sonkoly, Laguna Niguel, CA (US)

(21) Appl. No.: 18/379,804

(22) Filed: Oct. 13, 2023

(51) Int. Cl. G02B 6/42

(52) U.S. Cl. CPC G02B 6/428; G02B 6/4204

(57) ABSTRACT

An optoelectronic device includes an electrical transmission line comprising a first conductor and a second conductor formed on a electrical circuit substrate, a first plurality of electrically conductive structures formed on a surface of the first conductor and a second plurality of electrically conductive structures formed on a surface of the second conductor, a waveguide formed on a photonic integrated circuit (PIC), and a plurality of conversion segments formed on the PIC. Each conversion segment includes a first conversion structure electrically coupled to a respective one of the first plurality of electrically conductive structures and a second conversion structure electrically coupled to the corresponding one of the second plurality of electrically conductive structures, the first conversion structure and second conversion structure being configured for optoelectronic interaction with the waveguide.

### TECHNICAL FIELD

The present disclosure generally relates to optoelectronic devices and more particularly to transmission lines for high-speed optoelectronic devices.

### BACKGROUND

Some high-speed optoelectronic devices, such as modulators and photodetectors, may use a traveling wave structure to achieve higher performance levels, such as improved bandwidth and controlled impedance. These traveling wave structures are based on a transmission line that is loaded with several electro-optic or opto-electric segments (jointly referred to as “conversion segments”). The conversion segments are typically arranged along a length of the transmission line, either periodically or according to some other pattern. Both the transmission line and the conversion segments are formed on the photonic integrated circuit (PIC).

### BRIEF DESCRIPTION OF THE SEVERAL VIEWS OF THE DRAWINGS

The following description includes discussion of figures having illustrations given by way of example of implementations of embodiments of the disclosure. The drawings should be understood by way of example, and not by way of limitation. As used herein, references to one or more “examples” or “embodiments” are to be understood as describing a particular feature, structure, or characteristic included in at least one implementation of the inventive subject matter, in at least some circumstances. Thus, phrases such as “in one example”, “in some examples”, “in some embodiments”, “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any particular element or act, the most significant digit or digits in a reference number may refer to the figure (“FIG.”) number in which that element or act is first introduced.

FIG. 1 illustrates a top plan view of a conventional PCB for a conventional traveling wave optoelectronic device, providing context for some examples.

FIG. 2 illustrates a top plan view of a conventional PIC for a conventional traveling wave optoelectronic device, providing context for some examples.

FIG. 3 illustrates a top plan view of the conventional PIC of FIG. 2 inverted (shown in dotted lines) above the conventional PCB of FIG. 1 to form a conventional traveling wave optoelectronic device, providing context for some examples.

FIG. 4 illustrates a top plan view of a PCB for a traveling wave optoelectronic device, in accordance with some examples.

FIG. 5 illustrates a top plan view of a PIC for a traveling wave optoelectronic device, in accordance with some examples.

FIG. 6 illustrates a top plan view of the PIC of FIG. 5 inverted (shown in dotted lines) above the PCB of FIG. 4 to form an example traveling wave optoelectronic device, in accordance with some examples.

FIG. 7 illustrates a lateral view of the example traveling wave optoelectronic device of FIG. 6, in accordance with some examples.

FIG. 8 illustrates a top plan view of a second example PCB for a second example traveling wave optoelectronic device, in accordance with some examples.

FIG. 9 illustrates a top plan view of a second example PIC for a second example traveling wave optoelectronic device, in accordance with some examples.

FIG. 10 illustrates a top plan view of the PIC of FIG. 9 inverted (shown in dotted lines) above the PCB of FIG. 8 to form a second example traveling wave optoelectronic device, in accordance with some examples.

FIG. 11 illustrates a flowchart showing operations of a method of manufacturing an optoelectronic device, in accordance with some examples.

Descriptions of certain details and implementations follow, including a description of the figures, which may depict some or all of the embodiments described below, as well as discussing other potential embodiments or implementations of the inventive concepts presented herein. An overview of embodiments of the disclosure is provided below, followed by a more detailed description with reference to the drawings.

### DETAILED DESCRIPTION

In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, structures, and techniques are not necessarily shown in detail.

As used herein, the term “optoelectronic device” refers to both electrical-optical (also referred to as EO, electro-optic, electro-optical, electronic-optical, and so on) devices for modulating properties of an optical signal based on an electrical signal, and optical-electrical (also referred to as OE, opto-electrical, optic-electric, opto-electronic, and so on) devices for modulating properties of an electrical signal based on an optical signal, unless otherwise specified. Examples of EO devices include light modulators used in optical transmitters, such as Mach-Zender modulators (MZMs); examples of OE devices include photodetectors and other components used in optical receivers.

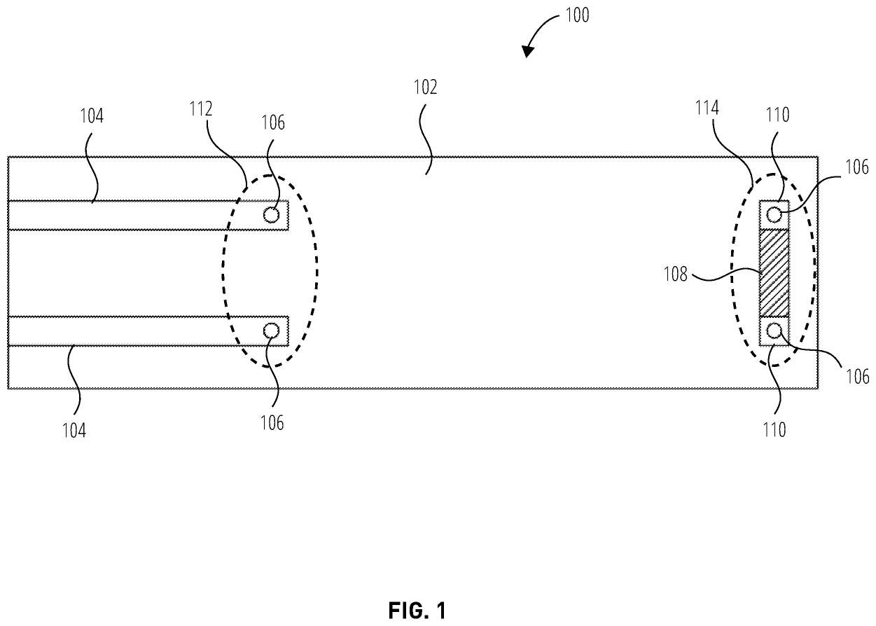

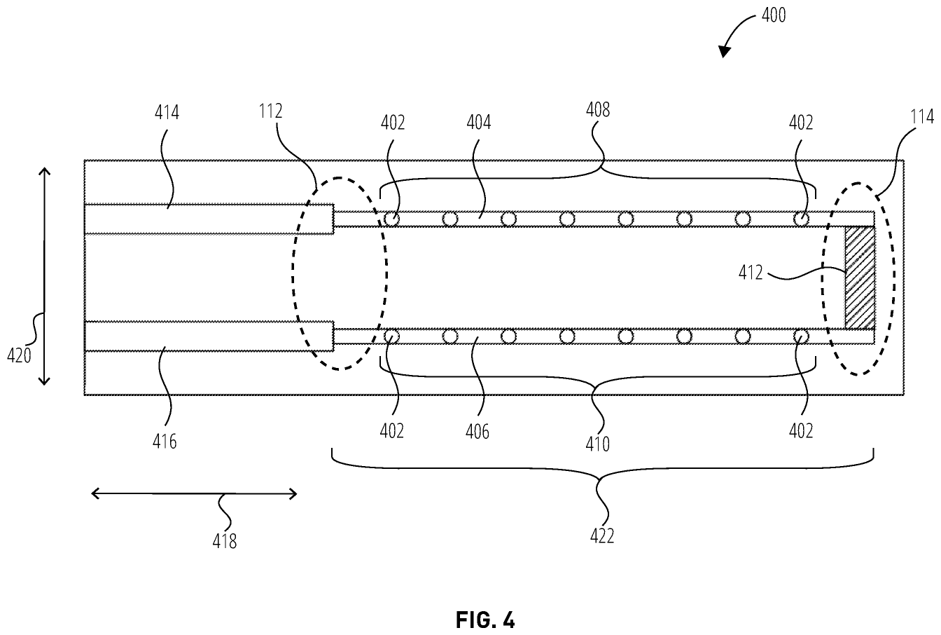

As described above, conventional traveling wave optoelectronic devices use electrical transmission lines formed on a PIC. However, electrical transmission lines formed on a PIC may exhibit limitations in terms of loss, bandwidth, and/or impedance. These conventional devices typically attempt to optimize the transmission lines and the connection inductance to the electro-optic or opto-electronic conversion segments on the PIC to improve the frequency response of the device, but are constrained by the limitations imposed by the PIC. Furthermore, a PIC tends to be limited in its ability to incorporate other electrical components to supplement or modify the behavior of the transmission lines and other electrical components of the optoelectronic device. Example structures for a traveling wave optoelectronic device using transmission lines on a PIC are described below with reference to FIG. 1 to FIG. 3, in order to provide context for the inventive examples described in FIG. 4 through FIG. 11.

Examples described herein provide an optoelectronic device, such as a traveling wave optoelectronic device, that uses a transmission line formed on a high-speed electrical circuit substrate such as a printed circuit board (PCB). The conversion segments providing the optoelectronic interaction between the transmission line and the waveguide carrying the optical signal are formed on the PIC, and may be electrically coupled to the transmission line by sets of electrically conductive structures, such as copper pillars or other electrical interconnects, formed on a surface of each conductor of the transmission line. The PIC may be connected to the PCB in a flip-chip configuration, such that the electrically conductive structures can be electrically connected to corresponding electrical contacts of the conversion segments. The conversion segments thereby load the transmission line in operation, either uniformly (e.g., periodically along a length of the transmission line) or non-uniformly (e.g., irregularly along the length of the transmission line).

By forming an electrical transmission line on the high-speed electrical circuit substrate, some examples may achieve improved performance and/or greater control over properties of the device, such as control over impedance and other electrical properties that affect device performance, such as frequency response, when processing high-speed signals. In some examples, the PCB may incorporate additional electrical components such as termination resistors, decoupling capacitors, or inductors to modify the behavior of the transmission line and/or the device as a whole. Electrical components such as electrical traces, conductors, and electrical interconnects can more readily be optimized on an electrical circuit substrate than on a PIC; thus, in some examples described herein, the only electrical components of the optoelectronic device formed on the PIC may be the waveguide and the conversion segments, including the electrical contacts of the conversion segments.

Some examples described herein may provide one or more benefits that address technical problems in the field of optoelectronic device design. By forming the transmission line on a PCB or other high-speed electrical circuit substrate, an optoelectronic device may exhibit lower transmission line loss, higher bandwidth, additional design parameters and flexibility for electrical components formed on the PCB, improved ability to combine the optoelectronic device with decoupling capacitors and other passive electronic components, and improved ability to separately optimize the electrical components on the PCB and the optical and optoelectronic components formed on the PIC.

Whereas examples described herein use a PCB as the high-speed electrical circuit substrate, it will be appreciated that the techniques described herein are potentially applicable to any high-speed electrical circuit substrate, whether single-layer or multi-layer, fabricated from any suitable material such as silicon, ceramic, organic material, and so on. Furthermore, whereas some examples described herein refer to incorporation of decoupling capacitors, the techniques described herein can be used to integrate various passive electronic components such as capacitors, inductors, and/or resistors with the electrical circuit components of the various examples described herein. In addition, in some examples, either or both of the PCB and the PIC can also include additional elements such as delay lines, termination resistance, decoupling capacitors, inductors, and so on to improve the functionality of the combined optoelectronic device.

FIG. 1 illustrates a top plan view of a conventional PCB 100 for a conventional traveling wave optoelectronic device. The device and components shown in FIG. 1 through FIG. 3 use a transmission line formed on a PIC, similar to conventional approaches to traveling wave optoelectronic device design described above. The examples shown in FIG. 1 through FIG. 3 thereby provide context for the examples described below with reference to FIG. 4 through FIG. 11.

In FIG. 1, a conventional PCB 100 includes a substrate 102, such as non-conductive surface layer of the PCB. A pair of electrically conductive traces 104 are formed on the substrate 102, and conductive pillars 106 extend upward (out of the plane of the drawing) from the traces 104, defining a first end 112 of the length of the optoelectronic portion of the device. Another pair of traces 110 is formed at the right end of the substrate 102, also having pillars 106 extending upward therefrom and defining a second end 114 of the optoelectronic portion of the device. A termination 108, such as one or more termination resistors, may optionally be formed between the traces 110 at the second end 114.

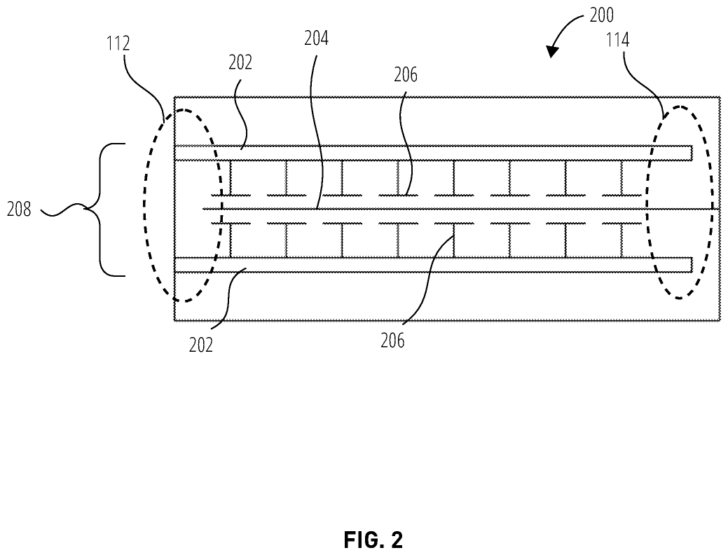

FIG. 2 illustrates a top plan view of a conventional PIC 200 for a conventional traveling wave optoelectronic device, intended to be coupled to the conventional PCB 100 of FIG. 1 to form a conventional traveling wave optoelectronic device.

Two conductors 202 are formed on a surface of the conventional PIC 200 between the first end 112 and second end 114 (intended to correspond to the first end 112 and second end 114 defined on the conventional PCB 100 in the final assembled device), thereby forming a transmission line 208. A waveguide 204 extends along a length of the conventional PIC 200, including through the first end 112 and second end 114. The conductors 202 are loaded with a series of conversion structures 206 configured to interact optoelectronically with the waveguide 204, such as electrodes configured to apply an electrical signal to the waveguide 204 (e.g., to modulate the properties of the optical signal propagated through the waveguide 204 based on an electrical signal propagated through the transmission line 208) or sense properties of the light in the waveguide 204 (e.g., to modulate the properties of an electrical signal propagated through the transmission line 208 based on the optical signal propagated through the waveguide 204).

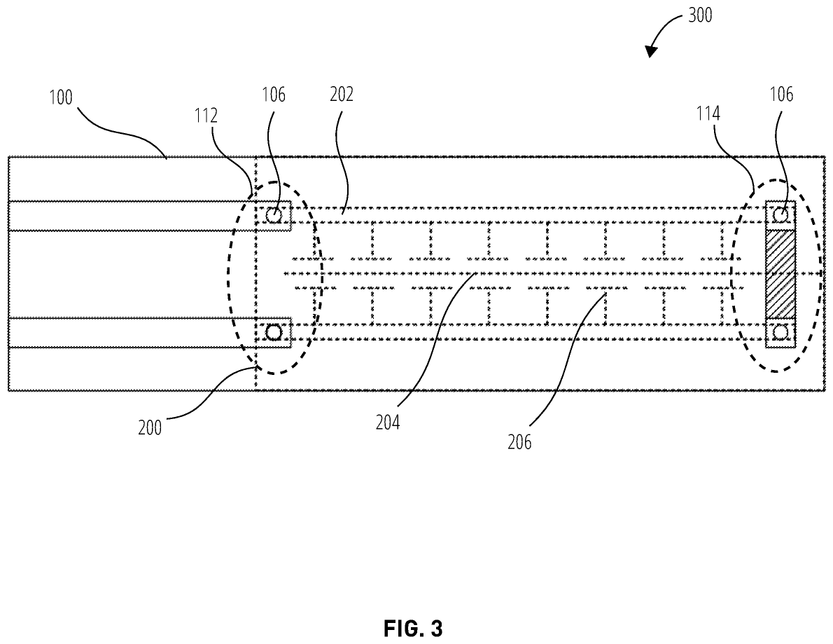

FIG. 3 illustrates a top plan view of the conventional PIC 200 of FIG. 2 inverted (as shown in dotted lines) into a flip-chip configuration above the conventional PCB 100 of FIG. 1 to form a conventional optoelectronic device 300.

In this configuration, the top ends of the pillars 106 are electrically connected to a surface of the conductors 202 (e.g., the top surface of the conductors 202 as shown in FIG. 2, but now bottom the surface in the inverted orientation of FIG. 3). In operation, an electrical signal may be propagated between the traces 104 at first end 112 and the traces 110 at second end 114 via the pillars 106 and conductors 202. An optical signal may simultaneously be propagated along the length of the waveguide 204. The optoelectrical interactions between the electrical signal and the optical signal are mediated by the conversion structures 206.

The example conventional optoelectronic device 300 is a traveling wave optoelectronic device using a transmission line 208 formed on the surface of the conventional PIC 200, and may therefore exhibit one or more of the limitations of such conventional approaches described above. FIG. 4 through FIG. 11, described below, illustrate examples that may address one or more of the technical problems presented by the limitations of the conventional optoelectronic device 300.

FIG. 4 illustrates a top plan view of a PCB 400 for a traveling wave optoelectronic device that uses a transmission line formed on the PCB 400. It will be appreciated that the devices illustrated in FIG. 4 through FIG. 10 may include one or more of the conventional features of the conventional optoelectronic device 300, such as a PCB 400 having a substrate 102 as described above with reference to FIG. 1.

The view of FIG. 4 is along a lamination axis of the PCB 400, such that the PCB 400 may include a stack of layers extending into the plane of the drawing. Perpendicular to the lamination axis, and to each other, are a longitudinal axis 418 defining a length of the PCB 400 and a lateral axis 420 defining a width of the PCB 400. Unless otherwise specified, words such as “length” and “longitudinal” as used herein may refer to distances along the longitudinal axis 418; words such as “width”, “lateral”, or “side” may refer to distances along the lateral axis 420; and words such as “height”, “up”, “down”, “vertical”, and so on may refer to distances along the lamination axis.

The PCB 400 differs from the conventional PCB 100 of FIG. 1 primarily in having an electrical transmission line 422, shown as first conductor 404 and second conductor 406, formed on the surface of the PCB 400 and defining a conductive path between the first end 112 and second end 114.

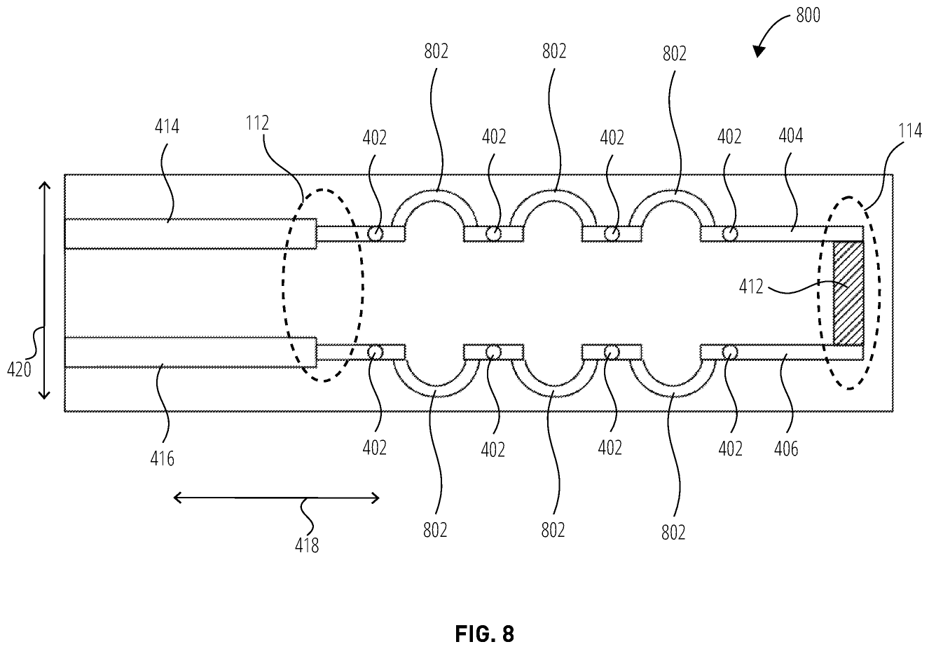

The first conductor 404 has a first plurality of electrically conductive structures 408 formed on its upper surface, whereas the second conductor 406 has a second plurality of electrically conductive structures 410 formed on its upper surface. The first plurality of electrically conductive structures 408 and second plurality of electrically conductive structures 410 may be jointly referred to as the electrically conductive structures of the optoelectronic device. In some examples, such as the illustrated example in FIG. 4, the spacing first plurality of electrically conductive structures 408 along the longitudinal axis 418 matches the corresponding spacing of the second plurality of electrically conductive structures 410. In some examples, this spacing may be either regular (e.g., periodic) or irregular. In some examples, the first conductor 404 and second conductor 406 do not form straight lines extending parallel to the longitudinal axis 418; instead, as in the example shown in FIG. 8 below, they may define a conductive path that includes one or more portions or segments that are at least partially transverse to (e.g., not parallel to) the longitudinal axis 418. In some such examples, the spacing of the first plurality of electrically conductive structures 408 and second plurality of electrically conductive structures 410 may be either regular or irregular with respect to a length of the conductive path as it changes direction.

Each electrically conductive structure 402 of the first plurality of electrically conductive structures 408 and second plurality of electrically conductive structures 410 may be a copper pillar or other electrical interconnect, as described above with reference to FIG. 1. In some examples, the electrically conductive structures 402 may be relatively short: the height of the pillars 106 used in the conventional PCB 100 may be suitable for the electrically conductive structures 402 of the PCB 400, for example, or a height of up to 200 micrometers (μm). In some examples, the height of the pillars is less than 100 μm, such as within the range of 40 μm-80 μm.

The PCB 400 includes a first electrical trace 414 and a second electrical trace 416 formed on the PCB 400 and electrically coupled to the first conductor 404 and second conductor 406, respectively. In some examples, the first electrical trace 414 and second electrical trace 416 may be wider than the first conductor 404 and second conductor 406, respectively, along the lateral axis 420; in other examples, the first electrical trace 414 and second electrical trace 416 may be narrower than the first conductor 404 and second conductor 406, respectively, along the lateral axis 420. Narrower traces may add inductance, thereby potentially slowing the velocity of the electrical signal propagation. In some examples, other changes may be made to the shape and/or spacing of the traces and/or the conductors in order to modify the frequency response of the optoelectronic device: for example, the traces and/or conductors may be lengthened, the traces and/or conductors may vary from a straight line shape, and/or the gap between the traces and/or between the conductors may be narrowed, to modify inductance and/or capacitance, instead of or in addition to narrowing the traces. In some examples, an inductor (not shown) may be formed on the electrical circuit substrate and electrically coupled to the electrical transmission line 422 to increase inductance. In some examples, the PCB 400 may also include a termination 412.

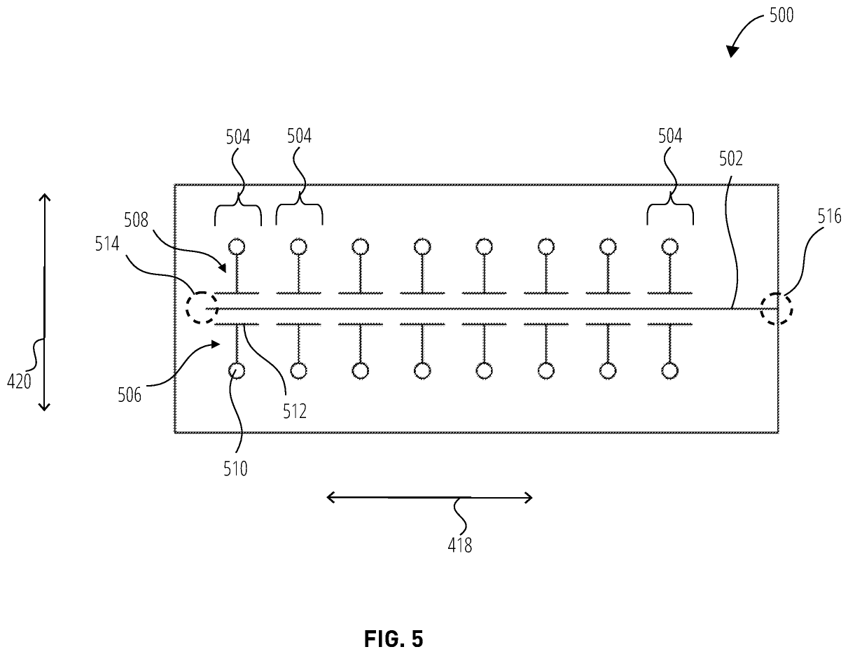

FIG. 5 illustrates a top plan view of a PIC 500 intended to couple with the PCB 400 to form a traveling wave optoelectronic device. Unlike the conventional PIC 200 of FIG. 2, the PIC 500 does not include a transmission line. Instead, conversion structures are formed on the surface of the PIC 500 in opposed pairs consisting of a first conversion structure 506 and a second conversion structure 508, each pair defining a conversion segment 504. The conversion segments 504 extend along at least a portion of the length of the waveguide 502, which extends between a first waveguide location 514 and a second waveguide location 516.

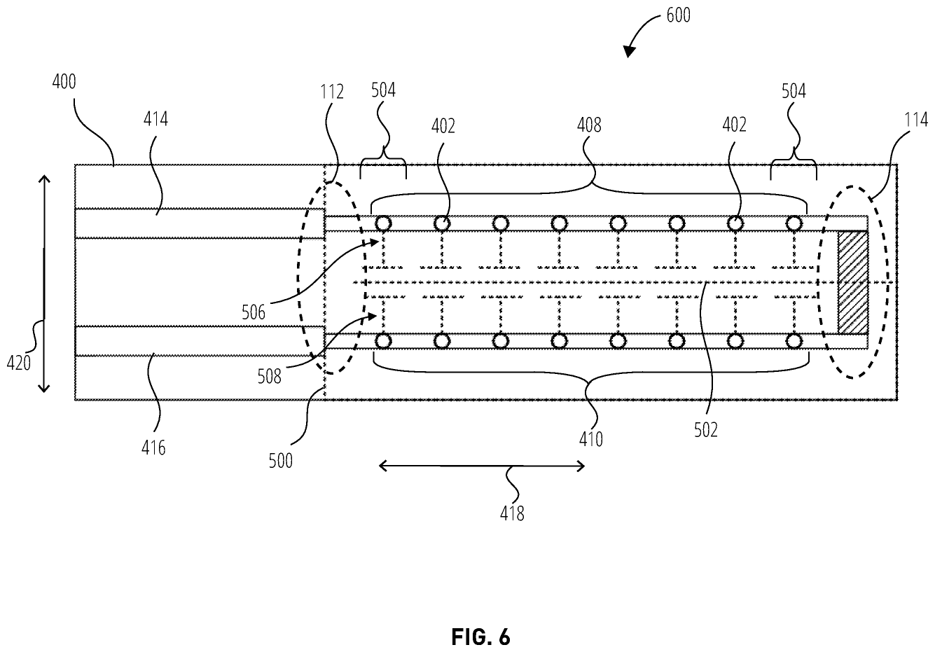

In the illustrated example, each first conversion structure 506 includes an electrode 512 for optoelectronic interaction with the waveguide 502, as well as a contact 510 for establishing electrical communication with a corresponding electrically conductive structure 402 of the first plurality of electrically conductive structures 408. Similarly, each second conversion structure 508 includes an electrode 512 for optoelectronic interaction with the waveguide 502 opposite the electrode 512 of its paired counterpart, as well as a contact 510 for establishing electrical communication with a corresponding electrically conductive structure 402 of the second plurality of electrically conductive structures 410. It will be appreciated that, in a flip-chip configuration in which the PIC 500 is rotated about the longitudinal axis 418 to invert it over the PCB 400, the second conversion structures 508 would be at the bottom of the drawing, whereas the first conversion structures 506 would be at the top, as shown in FIG. 6.

Thus, the PIC 500 may include a waveguide 502 formed on a surface of the PIC 500 and extending between a first waveguide location 514 and a second waveguide location 516. The first waveguide location 514 is separated from the second waveguide location 516 with respect to the longitudinal axis 418. The PIC 500 also includes a plurality of conversion segments 504 formed on the surface of the PIC 500, each conversion segment 504 having a first conversion structure 506 and a second conversion structure 508 configured for optoelectronic interaction with the waveguide 502. Each conversion segment 504 is electrically isolated from each other conversion segment on the surface of the PIC 500, as they are not joined by a transmission line formed on the PIC, unlike the conventional PIC 200 of FIG. 2. Each conversion segment 504 may be spaced either regularly (e.g., periodically) or irregularly with respect to the longitudinal axis 418.

FIG. 6 illustrates a top plan view of the PIC 500 inverted (as shown in dotted lines) above, and bonded to, the PCB 400 to form an example traveling wave optoelectronic device 600. The contacts 510 of each first conversion structure 506 are electrically coupled to the tops of the first plurality of electrically conductive structures 408, and the contacts 510 of each second conversion structure 508 are electrically coupled to the tops of the second plurality of electrically conductive structures 410. In this configuration, a differential electrical signal may be defined between the first conductor 404 and second conductor 406 and propagated thereby between the first end 112 and second end 114. At multiple points along the length s of the first conductor 404 and second conductor 406, a conversion segment 504 on the conventional optoelectronic device 300 is used for optoelectronic interaction with the waveguide 502 via the electrodes 512 of the first conversion structure 506 and second conversion structure 508 of the conversion segment 504, such that the optical signal propagated by the waveguide 502 modulates the differential electrical signal propagated by the first conductor 404 and second conductor 406, or vice versa.

I will be appreciated that the traveling wave structure of the optoelectronic device 600 allows it to be used in various applications. In some examples, the optoelectronic device 600 may be used as an electro-optical modulator or as part of an electro-optical modulator, such as one arm of an MZM.

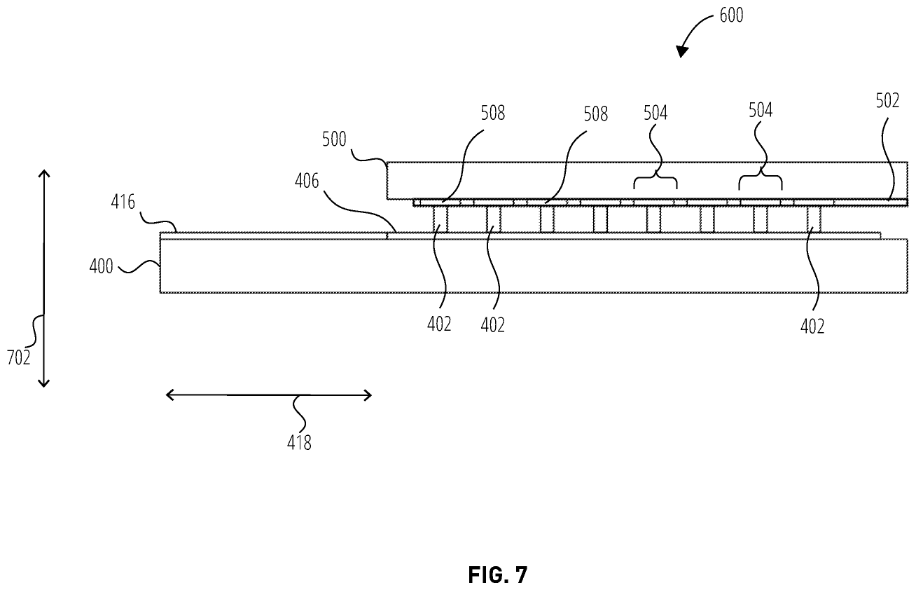

FIG. 7 illustrates a lateral view of the example traveling wave optoelectronic device 600, along the lateral axis 420. The lamination axis 702 is shown, perpendicular to the longitudinal axis 418.

The PCB 400 is shown arranged longitudinally beneath the inverted PIC 500. On the upper surface of the PCB 400, several components are visible in this view: second electrical trace 416, second conductor 406, and several electrically conductive structures 402 extending upward from the upper surface of the second conductor 406 to contact the second conversion structures 508 of the conversion segments 504. The waveguide 502 is visible behind the second conversion structures 508, and extending to the right end of the PIC 500.

Thus, in some examples, the optoelectronic device 600 includes a first conductor 404 and a second conductor 406 formed on a high-speed electrical circuit substrate (e.g., PCB 400) and extending between a first end 112 and a second end 114. The second end 114 is separated from the first end 112 with respect to the longitudinal axis 418. A plurality of electrically conductive structures 402 includes a first plurality of electrically conductive structures 408 formed on a surface of the first conductor 404 and a second plurality of electrically conductive structures 410 formed on a surface of the second conductor 406. Each electrically conductive structure 402 of the second plurality of electrically conductive structures 410 corresponds to a respective electrically conductive structure 402 of the first plurality of electrically conductive structures 408. A waveguide 502 formed on a PIC 500 extends between a first waveguide location 514 and a second waveguide location 516, the first waveguide location 514 being separated from the second waveguide location 516 with respect to the longitudinal axis 418. A plurality of conversion segments 504 are formed on the PIC 500. Each conversion segment 504 includes a first conversion structure 506 electrically coupled to a respective one of the first plurality of electrically conductive structures 408 and a second conversion structure 508 electrically coupled to the corresponding one of the second plurality of electrically conductive structures 410. The first conversion structure 506 and second conversion structure 508 are configured for optoelectronic interaction with the waveguide 502.

In some examples, the first plurality of electrically conductive structures 408 is spaced periodically with respect to the longitudinal axis 418 along the surface of the first conductor 404 between the first end 112 and the second end 114. In other examples, the first plurality of electrically conductive structures 408 is spaced irregularly with respect to the longitudinal axis 418 along the surface of the first conductor 404 between the first end 112 and the second end 114.

In some examples, the optoelectronic device 600 is a traveling wave optical-electrical device configured to modulate, based on properties of light propagating through the waveguide 502, a differential electrical signal propagating through the first conductor 404 and second conductor 406. In other examples, the optoelectronic device 600 is a traveling wave electrical-optical device configured to modulate, based on a differential electrical signal propagating through the first conductor 404 and second conductor 406, properties of light propagating through the waveguide 502.

Some examples may include a termination 412 formed on the electrical circuit substrate and electrically coupled to the first conductor 404 and second conductor 406 at the second end 114.

Some examples may include a first electrical trace 414 formed on the surface of the electrical circuit substrate, electrically coupled to the first conductor 404 at the first end 112, and having a narrower width along the lateral axis 420 than a width of the first conductor 404. Similarly, a second electrical trace 416 may be formed on the surface of the electrical circuit substrate, electrically coupled to the second conductor 406 at the first end 112 and having a narrower width along the lateral axis 420 than a width of the second conductor 406.

In some examples, the first conversion structure 506 and second conversion structure 508 are electrodes.

FIG. 8 illustrates a top plan view of a second example PCB 800 for a second example traveling wave optoelectronic device. In this example, the transmission line of the PCB 800 includes delay segments 802. These delay segment 802 may be used, in some examples, for impedance matching and/or to control the velocity of the differential electrical signal relative to the optical signal as they propagate along the longitudinal axis 418.

The first conductor 404 and second conductor 406 of the PCB 800 extend between the first end 112 and second end 114, as in the PCB 400 of FIG. 4. However, in this example PCB 800, the first conductor 404 and second conductor 406 include several delay segments 802. In the illustrated example, each delay segment 802 is situated between an adjacent pair of electrically conductive structures 402, and the delay segments 802 of the first conductor 404 mirror those of the second conductor 406.

The delay segment 802 introduce portions of the first conductor 404 and second conductor 406 that do not extend parallel to the longitudinal axis 418, but instead deviate from the longitudinal direction to extend at least partially transverse to the longitudinal axis 418. For example, the delay segments 802 shown in FIG. 8 are semi-circular in shape, defining portions of the conductive paths between the first end 112 and second end 114 that extend in roughly a 180 degree arc, which is at its ends parallel to the lateral axis 420 and perpendicular to the longitudinal axis 418, thereby providing a serpentine path for the conductors 404 and 406. It will be appreciated that other structures can be used for the delay segments 802 in other examples.

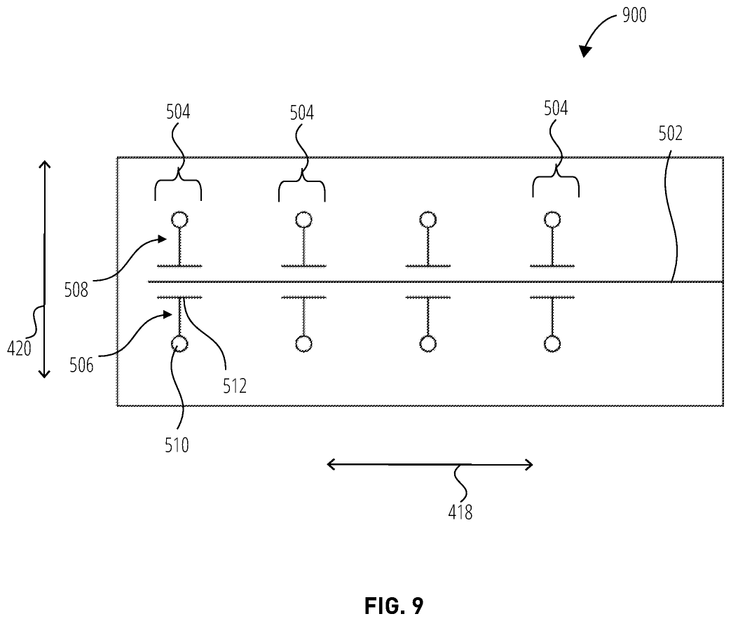

FIG. 9 illustrates a top plan view of a second example PIC 900 intended for coupling to the PCB 800 to form the second example traveling wave optoelectronic device. The PIC 900 has only four conversion segments 504 in the illustrated example, matching the number of pairs of electrically conductive structures 402 on the PCB 800. Otherwise, the PIC 900 is similar to the structure of the PIC 500 from FIG. 5.

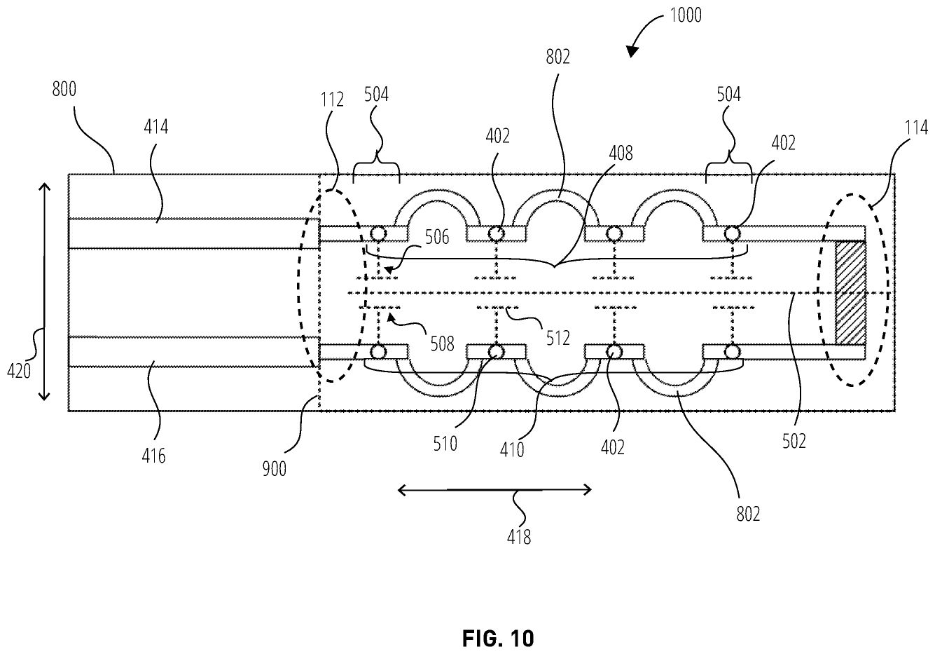

FIG. 10 illustrates a top plan view of the second example PIC 900, inverted in a flip-chip orientation (as shown in dotted lines) above the second example PCB 800 to form a second example traveling wave optoelectronic device 1000.

In a traveling-wave design, impedance typically needs to be calibrated to achieve the same velocity of the electrical and optical signals along the longitudinal axis 418. In some examples, such as the second example optoelectronic device 1000, this may be achieved by introducing delay segments 802 along the conductors 404 and 406. In other examples, similar effects may be achieved by narrowing the traces 414, 416 as described above.

Thus, in some examples, the optoelectronic device 1000 includes an electrical transmission line 422 comprising a first conductor 404 and second conductor 406, each comprising one or more delay segments 802, thereby each defining a respective electrically conductive path from the first end 112 to the second end 114 that includes, for each delay segment, at least a portion of the path that is at least partially transverse to the longitudinal axis 418.

In some examples, each delay segment 802 of the first conductor 404 includes a portion of the first conductor 404 in between a respective two adjacent electrically conductive structures 402 of the first plurality of electrically conductive structures 408.

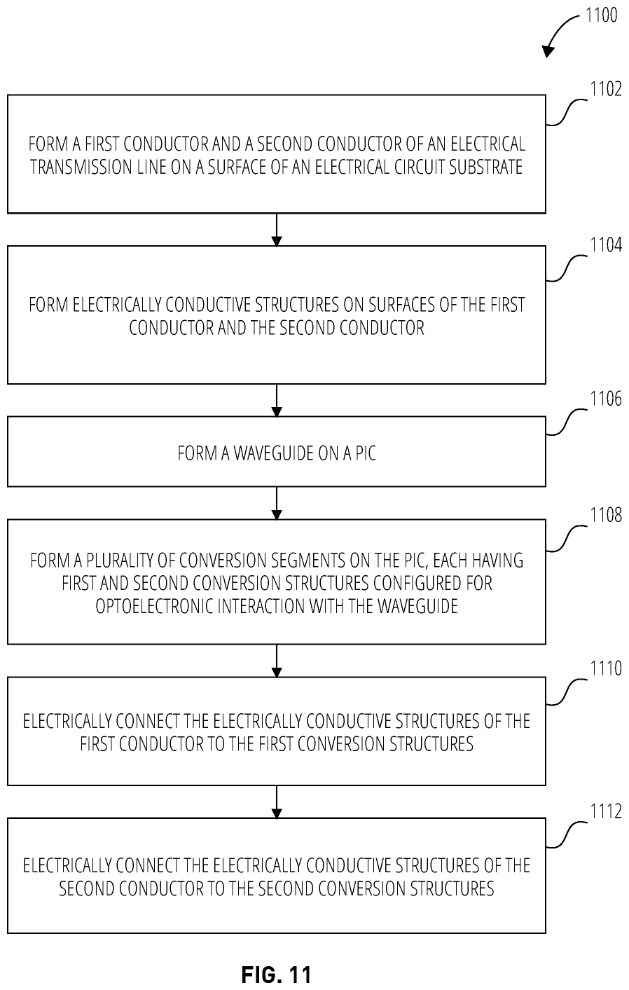

FIG. 11 shows operations of a method 1100 of manufacturing a optoelectronic device. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

According to some examples, the method 1100 includes forming a first conductor 404 and a second conductor 406 of an electrical transmission line 422 on a surface of a electrical circuit substrate (e.g., PCB 400) at operation 1102.

According to some examples, the method 1100 includes forming electrically conductive structures 402 on surfaces of the first conductor 404 and the second conductor 406 at operation 1104.

According to some examples, the method 1100 includes forming a waveguide (e.g., waveguide 502) on a PIC (e.g., PIC 500) at operation 1106.

According to some examples, the method 1100 includes forming a plurality of conversion segments (e.g., conversion segment 504) on the PIC, each having first and second conversion structures (e.g., first conversion structure 506 and second conversion structure 508) configured for optoelectronic interaction with the waveguide at operation 1108.

According to some examples, the method 1100 includes electrically connecting the electrically conductive structures of the first conductor 404 (e.g., first plurality of electrically conductive structures 408) to the first conversion structures (e.g., first conversion structures 506) at operation 1110.

According to some examples, the method 1100 includes electrically connecting the electrically conductive structures of the second conductor 406 (e.g., second plurality of electrically conductive structures 410) to the second conversion structures (e.g., second conversion structures 508) at operation 1112.

Thus, in some examples, a method 1100 of manufacturing an optoelectronic device (e.g., optoelectronic device 600 or optoelectronic device 1000) includes forming, on a surface of a electrical circuit substrate (e.g., PCB 400 or PCB 800), a first conductor 404 and a second conductor 406 extending between a first end 112 and a second end 114. The second end 114 is separated from the first end 112 with respect to a longitudinal axis 418. A first plurality of electrically conductive structures 408 are formed on a surface of the first conductor 404, and a second plurality of electrically conductive structures 410 are formed on a surface of the second conductor 406. Each electrically conductive structure 402 of the second plurality of electrically conductive structures 410 corresponds to a respective electrically conductive structure 402 of the first plurality of electrically conductive structures 408. A waveguide 502 is formed on a PIC (e.g., PIC 500 or PIC 900), the waveguide 502 extending between a first waveguide location 514 and a second waveguide location 516, the first waveguide location 514 being separated from the second waveguide location 516 with respect to the longitudinal axis 418. A plurality of conversion segments 504 are formed on the PIC, each including a first conversion structure 506 and a second conversion structure 508 configured for optoelectronic interaction with the waveguide 204. The first plurality of electrically conductive structures 408 is electrically connected to the first conversion structures 506 of the plurality of conversion segments 504. The second plurality of electrically conductive structures 410 is electrically connected to the second conversion structures 508 of the plurality of conversion segments 504.

In some examples, the method 1100 further includes forming a termination 412 on the electrical circuit substrate electrically coupled to the first conductor 404 and second conductor 406 at the second end 114.

In some examples, the method 1100 further includes forming a first electrical trace 414 on the surface of the electrical circuit substrate, having a narrower width along a lateral axis 420 than a width of the first conductor 404, and forming a second electrical trace 416 on the surface of the electrical circuit substrate, having a narrower width along the lateral axis 420 than a width of the second conductor 406. The first electrical trace 414 is electrically coupled to the first conductor 404 at the first end 112, and the second electrical trace 416 is electrically coupled to the second conductor 406 at the first end 112.

Examples described herein may thereby provide various techniques related to the configuration and manufacture of optoelectronic devices, such as traveling wave optoelectronic devices. Other examples of an optoelectronic device may include features, and combinations or subcombinations of features, of the various examples described herein.

In view of the disclosure above, various examples are set forth below. It should be noted that one or more features of an example, taken in isolation or combination, should be considered within the disclosure of this application.

The following are example embodiments:

Example 1 is an optoelectronic device comprising: an electrical transmission line, comprising a first conductor and a second conductor, formed on an electrical circuit substrate and extending between a first end and a second end, the second end being separated from the first end with respect to a longitudinal axis; a first plurality of electrically conductive structures formed on a surface of the first conductor and a second plurality of electrically conductive structures formed on a surface of the second conductor, each electrically conductive structure of the second plurality of electrically conductive structures corresponding to a respective electrically conductive structure of the first plurality of electrically conductive structures; a waveguide formed on a photonic integrated circuit (PIC) and extending between a first waveguide location and a second waveguide location, the first waveguide location being separated from the second waveguide location with respect to the longitudinal axis; and a plurality of conversion segments formed on the PIC, each conversion segment comprising a first conversion structure electrically coupled to a respective one of the first plurality of electrically conductive structures and a second conversion structure electrically coupled to the corresponding one of the second plurality of electrically conductive structures, the first conversion structure and second conversion structure being configured for optoelectronic interaction with the waveguide.

In Example 2, the subject matter of Example 1 includes, wherein: the electrical circuit substrate comprises a printed circuit board.

In Example 3, the subject matter of Examples 1-2 includes, wherein: the first plurality of electrically conductive structures is spaced periodically with respect to the longitudinal axis along the surface of the first conductor between the first end and the second end.

In Example 4, the subject matter of Examples 1-3 includes, wherein: the first plurality of electrically conductive structures is spaced irregularly with respect to the longitudinal axis along the surface of the first conductor between the first end and the second end.

In Example 5, the subject matter of Examples 1-4 includes, wherein: the first conductor and second conductor each comprise one or more delay segments, thereby each defining a respective electrically conductive path from the first end to the second end that includes, for each delay segment, at least a portion of the path that is at least partially transverse to the longitudinal axis.

In Example 6, the subject matter of Example 5 includes, wherein: each delay segment of the first conductor comprises a portion of the first conductor in between a respective two adjacent electrically conductive structures of the first plurality of electrically conductive structures.

In Example 7, the subject matter of Examples 1-6 includes, wherein: the optoelectronic device is a traveling wave optical-electrical device configured to modulate, based on properties of light propagating through the waveguide, an electrical signal propagating through the electrical transmission line.

In Example 8, the subject matter of Examples 1-7 includes, wherein: the optoelectronic device is a traveling wave electrical-optical device configured to modulate, based on an electrical signal propagating through the electrical transmission line, properties of light propagating through the waveguide.

In Example 9, the subject matter of Examples 1-8 includes, a termination formed on the electrical circuit substrate and electrically coupled to the first conductor and second conductor at the second end.

In Example 10, the subject matter of Examples 1-9 includes, a first electrical trace formed on the surface of the electrical circuit substrate, the first electrical trace having a narrower width along a lateral axis perpendicular to the longitudinal axis than a width of the first conductor, the first electrical trace being electrically coupled to the first conductor at the first end; and a second electrical trace formed on the surface of the electrical circuit substrate, the second electrical trace having a narrower width along the lateral axis than a width of the second conductor, the second electrical trace being electrically coupled to the second conductor at the first end.

In Example 11, the subject matter of Examples 1-10 includes, wherein: the first conversion structure and second conversion structure are electrodes.

In Example 12, the subject matter of Examples 1-11 includes, wherein: each electrically conductive structure extends from the surface of the first conductor to its respective first conversion structure, or from the surface of the second conductor to its respective second conversion structure, a distance of no more than 200 micrometers.

In Example 13, the subject matter of Example 12 includes, wherein: the distance is no more than 100 micrometers.

In Example 14, the subject matter of Example 13 includes, wherein the distance is between 40 and 80 micrometers.

In Example 15, the subject matter of Examples 1-14 includes, wherein: the electrical circuit substrate further includes a decoupling capacitor electrically coupled to the first conductor.

In Example 16, the subject matter of Examples 1-15 includes, an inductor formed on the electrical circuit substrate and electrically coupled to the electrical transmission line.

Example 17 is a method of manufacturing an optoelectronic device, comprising: forming, on a surface of a electrical circuit substrate, an electrical transmission line comprising a first conductor and a second conductor extending between a first end and a second end, the second end being separated from the first end with respect to a longitudinal axis; forming a first plurality of electrically conductive structures on a surface of the first conductor; forming a second plurality of electrically conductive structures on a surface of the second conductor, each electrically conductive structure of the second plurality of electrically conductive structures corresponding to a respective electrically conductive structure of the first plurality of electrically conductive structures; forming a waveguide on a photonic integrated circuit (PIC), the waveguide extending between a first waveguide location and a second waveguide location, the first waveguide location being separated from the second waveguide location with respect to the longitudinal axis; forming a plurality of conversion segments on the PIC, each conversion segment comprising a first conversion structure and a second conversion structure, the first conversion structure and second conversion structure being configured for optoelectronic interaction with the waveguide; electrically connecting the first plurality of electrically conductive structures to the first conversion structures of the plurality of conversion segments; and electrically connecting the second plurality of electrically conductive structures to the second conversion structures of the plurality of conversion segments.

In Example 18, the subject matter of Example 17 includes, wherein: the first conductor and second conductor each comprise one or more delay segments, thereby each defining a respective electrically conductive path from the first end to the second end that includes, for each delay segment, at least a portion of the path that is at least partially transverse to the longitudinal axis.

In Example 19, the subject matter of Examples 17-18 includes, forming a termination on the electrical circuit substrate electrically coupled to the first conductor and second conductor at the second end.

In Example 20, the subject matter of Examples 17-19 includes, forming a first electrical trace on the surface of the electrical circuit substrate, the first electrical trace having a narrower width along a lateral axis perpendicular to the longitudinal axis than a width of the first conductor, the first electrical trace being electrically coupled to the first conductor at the first end; and forming a second electrical trace on the surface of the electrical circuit substrate, the second electrical trace having a narrower width along the lateral axis than a width of the second conductor, the second electrical trace being electrically coupled to the second conductor at the first end.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Other technical features may be readily apparent to one skilled in the art from the figures, descriptions, and claims.

What is claimed is:

1. An optoelectronic device comprising:
an electrical transmission line, comprising a first conductor and a second conductor, formed on an electrical circuit substrate and extending between a first end and a second end, the second end being separated from the first end with respect to a longitudinal axis;
a first plurality of electrically conductive structures formed on a surface of the first conductor and a second plurality of electrically conductive structures formed on a surface of the second conductor, each electrically conductive structure of the second plurality of electrically conductive structures corresponding to a respective electrically conductive structure of the first plurality of electrically conductive structures;
a waveguide formed on a photonic integrated circuit (PIC) and extending between a first waveguide location and a second waveguide location, the first waveguide location being separated from the second waveguide location with respect to the longitudinal axis; and
a plurality of conversion segments formed on the PIC, each conversion segment comprising a first conversion structure electrically coupled to a respective one of the first plurality of electrically conductive structures and a second conversion structure electrically coupled to the corresponding one of the second plurality of electrically conductive structures, the first conversion structure and second conversion structure being configured for optoelectronic interaction with the waveguide.

2. The optoelectronic device of claim 1, wherein:
the electrical circuit substrate comprises a printed circuit board.

3. The optoelectronic device of claim 1, wherein:
the first plurality of electrically conductive structures is spaced periodically with respect to the longitudinal axis along the surface of the first conductor between the first end and the second end.

4. The optoelectronic device of claim 1, wherein:
the first plurality of electrically conductive structures is spaced irregularly with respect to the longitudinal axis along the surface of the first conductor between the first end and the second end.

5. The optoelectronic device of claim 1, wherein:
the first conductor and second conductor each comprise one or more delay segments, thereby each defining a respective electrically conductive path from the first end to the second end that includes, for each delay segment, at least a portion of the path that is at least partially transverse to the longitudinal axis.

6. The optoelectronic device of claim 5, wherein:
each delay segment of the first conductor comprises a portion of the first conductor in between a respective two adjacent electrically conductive structures of the first plurality of electrically conductive structures.

7. The optoelectronic device of claim 1, wherein:
the optoelectronic device is a traveling wave optical-electrical device configured to modulate, based on properties of light propagating through the waveguide, an electrical signal propagating through the electrical transmission line.

8. The optoelectronic device of claim 1, wherein:
the optoelectronic device is a traveling wave electrical-optical device configured to modulate, based on an electrical signal propagating through the electrical transmission line, properties of light propagating through the waveguide.

9. The optoelectronic device of claim 1, further comprising:
a termination formed on the electrical circuit substrate and electrically coupled to the first conductor and second conductor at the second end.

10. The optoelectronic device of claim 1, further comprising:
a first electrical trace formed on the surface of the electrical circuit substrate, the first electrical trace having a narrower width along a lateral axis perpendicular to the longitudinal axis than a width of the first conductor, the first electrical trace being electrically coupled to the first conductor at the first end; and
a second electrical trace formed on the surface of the electrical circuit substrate, the second electrical trace having a narrower width along the lateral axis than a width of the second conductor, the second electrical trace being electrically coupled to the second conductor at the first end.

11. The optoelectronic device of claim 1, wherein:
the first conversion structure and second conversion structure are electrodes.

12. The optoelectronic device of claim 1, wherein:
each electrically conductive structure extends from the surface of the first conductor to its respective first conversion structure, or from the surface of the second conductor to its respective second conversion structure, a distance of no more than 200 micrometers.

13. The optoelectronic device of claim 12, wherein:
the distance is no more than 100 micrometers.

14. The optoelectronic device of claim 13, wherein
the distance is between 40 and 80 micrometers.

15. The optoelectronic device of claim 1, wherein:
the electrical circuit substrate further includes a decoupling capacitor electrically coupled to the first conductor.

16. The optoelectronic device of claim 1, further comprising:
an inductor formed on the electrical circuit substrate and electrically coupled to the electrical transmission line.

17. A method of manufacturing an optoelectronic device, comprising:
forming, on a surface of a electrical circuit substrate, an electrical transmission line comprising a first conductor and a second conductor extending between a first end and a second end, the second end being separated from the first end with respect to a longitudinal axis;
forming a first plurality of electrically conductive structures on a surface of the first conductor;
forming a second plurality of electrically conductive structures on a surface of the second conductor, each electrically conductive structure of the second plurality of electrically conductive structures corresponding to a respective electrically conductive structure of the first plurality of electrically conductive structures;
forming a waveguide on a photonic integrated circuit (PIC), the waveguide extending between a first waveguide location and a second waveguide location, the first waveguide location being separated from the second waveguide location with respect to the longitudinal axis;
forming a plurality of conversion segments on the PIC, each conversion segment comprising a first conversion structure and a second conversion structure, the first conversion structure and second conversion structure being configured for optoelectronic interaction with the waveguide;
electrically connecting the first plurality of electrically conductive structures to the first conversion structures of the plurality of conversion segments; and
electrically connecting the second plurality of electrically conductive structures to the second conversion structures of the plurality of conversion segments.

18. The method of claim 17, wherein:
the first conductor and second conductor each comprise one or more delay segments, thereby each defining a respective electrically conductive path from the first end to the second end that includes, for each delay segment, at least a portion of the path that is at least partially transverse to the longitudinal axis.

19. The method of claim 17, further comprising:
forming a termination on the electrical circuit substrate electrically coupled to the first conductor and second conductor at the second end.

20. The method of claim 17, further comprising:
forming a first electrical trace on the surface of the electrical circuit substrate, the first electrical trace having a narrower width along a lateral axis perpendicular to the longitudinal axis than a width of the first conductor, the first electrical trace being electrically coupled to the first conductor at the first end; and
forming a second electrical trace on the surface of the electrical circuit substrate, the second electrical trace having a narrower width along the lateral axis than a width of the second conductor, the second electrical trace being electrically coupled to the second conductor at the first end.
